(19) United States
(12) Patent Application Publication
(10) Pub. No.: US 2014/0069750 A1
(43) Pub. Date: Mar. 13, 2014

(54) ELECTRIC BRAKE DEVICE AND METHOD FOR CONTROLLING ELECTRIC BRAKE DEVICE

(71) Applicants: Shun Nohira, Anjo-shi (JP); Yusuke Oshio, Anjo-shi (JP)

(72) Inventors: Shun Nohira, Anjo-shi (JP); Yusuke Oshio, Anjo-shi (JP)

(73) Assignee: ADVICS CO., LTD., Kariya-city, Aichi-pref. (JP)

(21) Appl. No.: 14/114,671

(22) PCT Filed: May 23, 2012
(86) PCT No.: PCT/JP2012/063129

§ 371 Date: Oct. 29, 2013

(30) Foreign Application Priority Data
May 24, 2011 (JP) 2011-115599

(51) Int. Cl. F16D 65/62

(52) U.S. Cl. CPC F16D 65/62
USPC 188/71.8

(57) ABSTRACT

A brake actuator converts the rotation of an electric motor into a linear movement to transmit the linear movement to a piston and, by the piston, presses a brake pad against a disc rotor to generate a brake force on a wheel. When a braking operation is finished, a brake control device rotates the electric motor in a direction corresponding to a return direction and detects a rotational position of the electric motor when the brake force is removed. The brake control device further rotates the electric motor in the return direction and restricts the rotation of the electric motor by a lock mechanism after adjusting the rotational position of the electric motor so that the difference between the rotational position when the brake force is removed, and the present rotational position of the electric motor comes into a reference rotational range.

### TECHNICAL FIELD

The present invention relates to an electric brake device for driving an electric motor to apply a brake force to a wheel and a control method for the electric brake device.

### BACKGROUND ART

There is a prior art relating to an electric brake device which is mounted by a wheel and in which a brake force is applied to the wheel by operating an electric motor (refer to Patent Document 1, for example). When a brake pedal is operated, the electric brake device disclosed in Patent Document 1 converts the rotation of an electric motor into a linear movement through a ball screw and linearly moves a pressuring member to press a brake pad on a disc rotor.

In the aforementioned electric brake device, a compression spring is interposed between the pressing member for pressing the brake pad and a caliper, and when a brake pedal is not operated, the pressing member is forcibly moved by an urging force generated by the compression spring, whereby the brake pad is returned in the direction to go away from the disc rotor.

Thus, also at the time of malfunction of the electric motor, it is possible to prevent the wheel from being dragged or locked, so that a braking operation unexpected by the driver can be prevented.

### PRIOR ART DOCUMENT

### Patent Document

Patent Document 1: JP2005-247306 A

### SUMMARY OF THE INVENTION

### Problem to be Solved by the Invention

However, in the electric brake device disclosed in Patent Document 1, the pressing member is forcibly returned by the compression spring. Thus, whenever the operation of the brake pedal is finished, the pressing member is returned to the maximum return position, so that a predetermined gap is formed between the brake pad and the disc rotor. Therefore, when the brake pedal is operated at the next time, a time is taken for the brake pad to come into contact with the disc rotor, which gives rises to an anxiety that a delay in response occurs in the braking operation.

In order to prevent this, it is necessary to keep the electric motor electrified and to control the operation of the same so that when the brake pedal is out of operation, the pressing member is held in such a position that does not cause the delay in operation. This may result in an increase in electricity consumption as well as in the deterioration, heating and a short service life of the electric motor.

Further, in the electric brake device disclosed in Patent Document 1, there is an anxiety that when the malfunction of the electric motor and the ageing degradation of the compression spring take place at a time, the brake dragging occurs due to the insufficiency in the return amount of the pressing member, on the contrary to the aforementioned case.

The present invention has been made taking the aforementioned circumstance into consideration, and an object thereof is to provide an electric brake device which is excellent in responsiveness of operation, and a control method for the electric brake device.

### Solution to the Problem

In order to solve the foregoing problem, the construction of an electric brake device in the invention according to a first aspect resides in comprising a piston that presses a braking member on a braked member rotating bodily with a wheel; brake force detecting means that detects a brake force generated on the braked member; an electric motor that rotates by being supplied with electric current based on a braking operation amount and a brake force detected by the brake force detection means; a movement direction converting mechanism that converts the rotation of the electric motor into a linear movement to transmit the linear movement to the piston; urging means that urges the electric motor to rotate in a return direction being the direction in which the braking member goes away from the braked member; a lock mechanism that is able to hold the electric motor with the rotation restricted in at least the return direction; and control means that controls the operations of the electric motor and the lock mechanism; wherein the control means includes gap judging means that judges whether or not the gap amount between the braking member and the braked member exists within a reference range, when the braking member is not in a pressing state; and gap adjusting means that drives the electric motor to adjust the gap amount when the gap amount is judged by the gap judging means not to exist within the reference range; and wherein the control means, when the braking member is not in the pressing state, drives the electric motor to adjust the gap amount so that the gap amount comes into the reference range, and restricts the rotation of the electric motor by the lock mechanism with the gap amount having been adjusted.

The construction of the invention according to a second aspect resides in that in the electric brake device in the first aspect, the lock mechanism is included in an electric parking brake device that, at the time of parking the vehicle, restricts the rotation of the electric motor with a brake force generated on the braked member.

The construction of the invention according to a third aspect resides in that in the electric brake device in the first or second aspect, the device further comprises motor position detecting means that detects the rotational position of the electric motor; and that the control means has a reference rotational range set as values which are obtained by converting the reference range into the rotational positions of the electric motor, and in adjusting the gap amount, takes as an origin position a rotational position of the electric motor when a brake force generated on the braked member and detected by the brake force detecting means is removed as the piston is moved in the return direction after releasing the pressing by the braking member, and adjusts the rotational position of the electric motor so that the difference between the rotational position of the electric motor and the origin position in a further movement of the piston in the return direction comes into the reference rotational range.

The construction of the invention according to a fourth aspect resides in that in the electric brake device in any one of the first to third aspects, the control means corrects the gap amount based on a change in temperature of the braking member or the braked member, when the braking member is not in the pressing state.

The construction of a control method for an electric brake device in the invention according to a fifth aspect resides in comprising a piston that presses a braking member on a braked member rotating bodily with a wheel; brake force detecting means that detects a brake force generated on the braked member; an electric motor that rotates by being supplied with electric current based on a braking operation amount and a brake force detected by the brake force detecting means; a movement direction converting mechanism that converts the rotation of the electric motor into a linear movement to transmit the linear movement to the piston; urging means that urges the electric motor in a return direction being the direction in which the braking member goes away from the braked member; and a lock mechanism that is able to hold the electric motor with the rotation restricted in at least the return direction; the method comprising a gap judging step of judging whether or not the gap amount between the braking member and the braked member exists within a reference range, when the braking member is not in a pressing state; and a gap adjusting step of adjusting the gap amount by driving the electric motor when the gap amount is judged at the gap judging step not to exist within the reference range; wherein when the braking member is not in the pressing state, the gap amount is adjusted by driving the electric motor so that the gap amount comes into the reference range, and with the gap amount having been adjusted, the rotation of the electric motor is restricted by the lock mechanism.

### Effects of the Invention

According to the electric brake device in the first aspect, when the braking member is not in the pressing state, the electric motor is driven to adjust the gap amount between the braking member and the braked member so that the gap amount comes into the reference range, and the rotation of the electric motor is restricted by the lock mechanism with the gap amount having been adjusted. Therefore, it is possible to hold the rotational position of the electric motor with the gap amount existing within the reference range, when the brake is out of operation. In spite of the wear on the braking member or the deterioration of the urging means, it is also possible to prevent the dragging or locking while the brake is not being operated, and to improve the responsiveness in operation when the next braking operation is performed.

Further, the rotation of the electric motor is restricted by the lock mechanism with the gap amount between the braking member and the braked member existing within the reference range. Therefore, when the brake is not being operated, it is possible to hold the position of the braking member without operating the electric motor and hence, to realize a decrease in electric power consumption, the prevention of the electric motor from deterioration and heating, and a long service life.

Further, since the position of the piston is not required to be kept by the electric motor for a long period of time, it becomes possible to downsize the electric motor and to realize a reduction in cost of the electric brake device.

According to the electric brake device in the second aspect, since the lock mechanism is included in the electric parking brake device that restricts the rotation of the electric motor at the time of parking the vehicle, it is not necessary to provide a lock mechanism additionally for the holding of the rotational position of the electric motor. As a result, the electric brake device can be made to be easy in manufacturing and low in cost.

According to the electric brake device in the third aspect, the reference rotational range is taken as the values which are obtained by converting the reference range into the rotational positions of the electric motor. In adjusting the gap amount, the origin position is set as the rotational position of the electric motor where the brake force generated on the braked member is removed as the piston is moved in the return direction after releasing the pressing by the braking member, and the rotational position of the electric motor is adjusted so that the difference between the rotational position of the electric motor and the origin position in a further movement of the piston in the return direction comes into the reference rotational range. Therefore, it is possible to easily adjust the gap amount between the braking member and the braked member when the braking operation is released.

According to the electric brake device in the fourth aspect, when the braking member is not in the pressing state, the gap amount is corrected based on a change in temperature of the braking member or the braked member. Therefore, even if, when the rotation of the electric motor is restricted, a change in shape occurs on the braking member or the braked member due to a change in temperature to vary the gap amount therebetween, it is possible to correct the gap amount again to an appropriate amount.

According to the control method for the electric brake device in the fifth aspect, when the braking member is not in the pressing state, the electric motor is driven to adjust the gap amount so that the gap amount comes into the reference range, and the rotation of the electric motor is restricted by the lock mechanism with the gap amount having been adjusted. Therefore, it is possible to hold the rotational position of the electric motor with the gap amount existing within the reference range when the brake is out of operation. In spite of the wear on the braking member or the deterioration of the urging means, it is also possible to prevent the dragging or locking while the brake is not being operated, and to improve the responsiveness in operation when the next braking operation is performed.

Further, the rotation of the electric motor is restricted by the lock mechanism with the gap amount between the braking member and the braked member having been adjusted. Therefore, when the brake is not being operated, it is possible to hold the position of the braking member without operating the electric motor and hence, to realize a decrease in electric power consumption, the prevention of the electric motor from deterioration and heating, and a long service life.

Further, since the position of the piston is not required to be kept by the electric motor for a long period of time, it becomes possible to downsize the electric motor and to realize a reduction in cost of the electric brake device.

### BRIEF DESCRIPTION OF THE DRAWINGS

FIG. 1 is a block diagram showing the entire construction of an electric brake device in one embodiment according to the present invention.

FIG. 2 is a perspective exterior view showing a brake actuator shown in FIG. 1 in an engaged state with a disc rotor.

FIG. 3 is a sectional view showing the brake actuator shown in FIG. 2 taken along the rotational axis of the disc rotor.

FIG. 4 is a view schematically showing a lock mechanism shown in FIG. 3.

FIG. 5 is a flowchart showing the first half of a control method for the electric brake device.

FIG. 6 is a flowchart showing the second half of the control method for the electric brake device.

FIG. 7 is a simplified chart for explaining an adjusting method of a gap amount between a brake pad and the disc rotor.

### EMBODIMENT FOR PRACTICING THE INVENTION

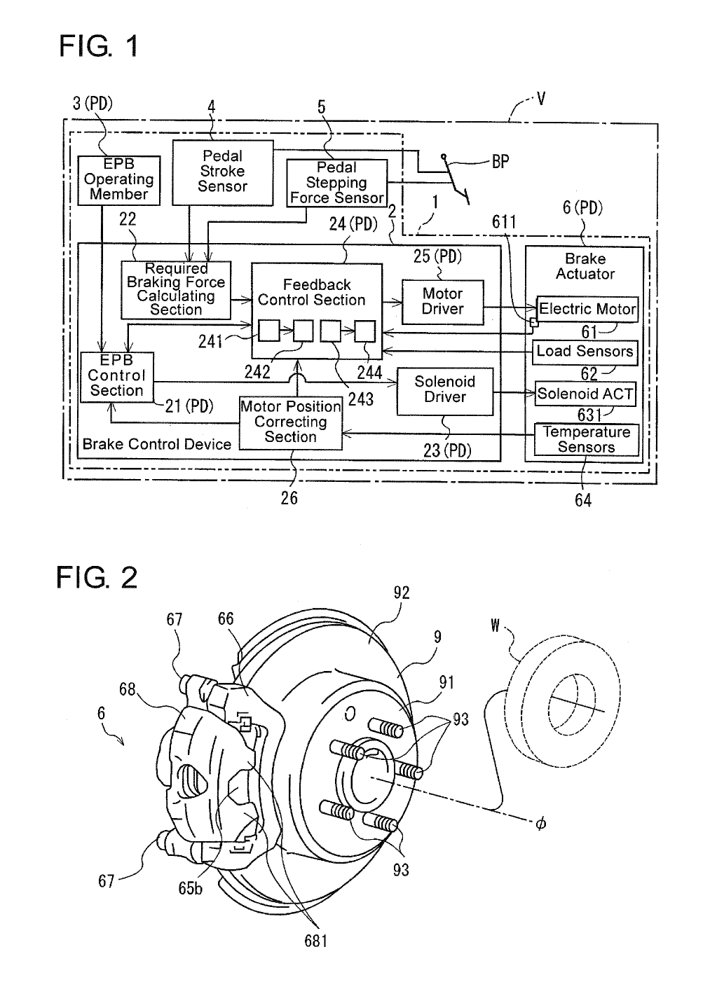

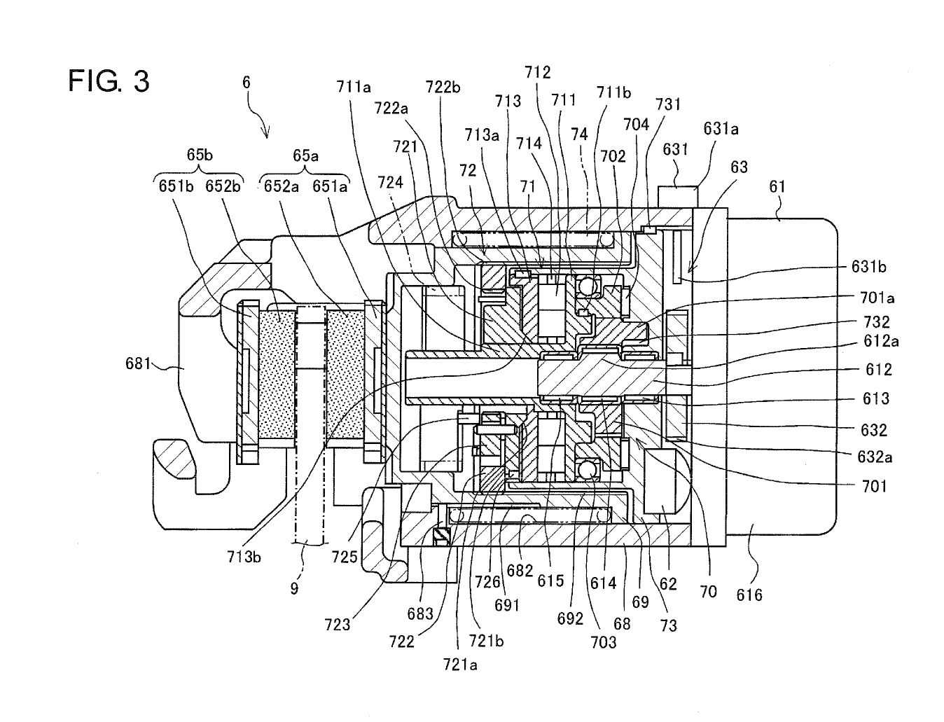

Next, an electric brake device 1 in one embodiment of the present invention will be described with reference to FIGS. 1 to 7. In a brake actuator 6 shown in FIG. 3, the left-right direction indicates the direction in which the rotational axis φ of a disc rotor 9 (corresponding to a braked member) referred to later extends. Further, in FIG. 3, it may occasionally be the case that the left is regarded as forward side and the right is regarded as rearward side.

As shown in FIG. 1, the electric brake device 1 in the present embodiment is attached to a vehicle V and is provided with a brake control device 2 (corresponding to control means) and the brake actuator 6 which is controlled by the brake control device 2 in operation.

The brake actuator 6 is provided with an electric motor 61, a load sensors 62 (corresponding to brake force detecting means), a solenoid actuator 631 included in a lock mechanism 63 (referred to later), and temperature sensors 64 attached to brake pads 65a, 65b (corresponding to braking members). The brake actuator 6 will be described later.

Further, the brake control device 2 is electrically connected to an EPB operating member 3, a pedal stroke sensor 4 and a pedal stepping force sensor 5 provided in the vehicle V. The EPB operating member 3 is included in an electric parking brake (EPB) device PD and is configured by, for example, a push button, though not limited to the same, which is provided on a dashboard to be pushed by the driver.

The pedal stroke sensor 4 and the pedal stepping force sensor 5 respectively detect the operation stroke and the operation stepping force of a brake pedal BP as the operation amount of a foot brake (service brake) in the vehicle V. In the vehicle V, either one only of the pedal stroke sensor 4 and the pedal stepping force sensor 5 may be provided.

The brake control device 2 is a computer device which is provided with a CPU, a calculation device, a memory device, an input/output device and the like, and is provided with an EPB control section 21 connected to an EPB operating member 3 and a required brake force calculating section 22 connected to the pedal stroke sensor 4 and the pedal stepping force sensor 5.

The required brake force calculating section 22 calculates a required brake force based on the operation amount of the brake pedal BP detected by the pedal stroke sensor 4 or the pedal stepping force sensor 5.

The EPB control section 21 is connected to the aforementioned solenoid actuator 631 through a solenoid driver 23. Further, the EPB control section 21 and the required brake force calculating section 22 are both connected to a feedback control section 24.

The feedback control section 24 is connected to the electric motor 61 through a motor driver 25. Further, the feedback control section 24 is connected to a resolver 611 (corresponding to motor position detecting means) for detecting the rotational position of the electric motor 61 and the load sensors 62 for detecting the brake force given by the brake actuator 6.

Further, the feedback control section 24 includes a brake force judging section 241 and a brake force adjusting section 242. The brake force judging section 241 judges whether or not the brake force of the brake actuator 6 detected by the load sensors 62 meets the required brake force calculated by the required brake force calculating section 22.

Furthermore, the brake force adjusting section 242 adjusts the brake force of the brake actuator 6 by driving the electric motor 61 when the brake force of the brake actuator 6 does not meet the required brake force.

Further, the feedback control section 24 includes a gap judging section 243 (corresponding to gap judging means) and a gap adjusting section 244 (corresponding to gap adjusting means). The gap judging section 243 judges whether or not the gap amount between the brake pads 65a, 65b referred to later and the disc rotor 9 (hereinafter referred to simply as gap amount) exists within a reference range when the brake pads 65a, 65b are not in a pressing state on the disc rotor 9. When the gap amount is judged by the gap judging section 243 not to exist within the reference range, the gap adjusting section 244 drives the electric motor 61 to adjust the gap amount.

Furthermore, a motor position correcting section 26 is connected to the EPB control section 21 and the feedback control section 24. The motor position correcting section 26 is also connected to the temperature sensors 64 provided on the brake pads 65a, 65b.

As shown in FIG. 2, the disc rotor 9 not included in the construction of the present invention has a hat portion 91 protruding outward from the vehicle V on its rotation center and a plate portion 92 formed around the hat portion 91 and being able to be put to be pressed between the first brake pad 65a and the second brake pad 65b, as referred to later.

A plurality of stud bolts 93 protrude from an end surface of the hat portion 91. The disc rotor 9 is attached to a disc wheel of a wheel W by the use of these stud bolts 93 and is rotatable integrally with the wheel W.

A mounting 66 for the brake actuator 6 is fixedly attached to a knuckle arm (not shown) of the vehicle V. The mounting 66 holds the first brake pad 65a and the second brake pad 65b (hereinafter, both called brake pads 65a, 65b collectively; the second brake pad 65b only shown in FIG. 2). The first brake pad 65a is arranged between the disc rotor 9 and a piston 69 (referred to later). The first brake pad 65a and the second brake pad 65b take a construction that linings 652a, 652b as friction members are respectively jointed to back plates 651a, 651b (shown in FIG. 3).

A brake housing 68 is mounted on the mounting 66 through a pair of sliding pins 67 movably in the rotational axis φ direction of the disc rotor 9 (hereafter referred to as rotational axis direction). The cross section of the brake housing 68 takes almost a U-shape to stride over the plate portion 92 of the disc rotor 9 (shown in FIGS. 2 and 3). Further, the brake housing 68 is formed with a pair of claw portions 681 for pressing the second brake pad 65b.

As shown in FIG. 3, a cylinder portion 682 is formed inside the brake housing 68, and the electric motor 61 is attached to close an end of the cylinder portion 682. A rotational shaft 612 protrudes from the electric motor 61 to enter the cylinder portion 682.

A piston 69 is arranged in the cylinder portion 682 in contact with the first brake pad 65a. The piston 69 is formed on the external surface thereof with a guide groove 691 extending in the rotational axis direction. The guide groove 691 is engaged with a guide pin 683 detachably provided in the brake housing 68. Thus, the piston 69 is configured to be movable in the rotational axis direction and not to be rotatable inside the cylinder portion 682.

The piston 69 takes a cup shape and, by a return spring 74 (corresponding to urging means) interposed between itself and the cylinder portion 682, is urged in the return direction (rightward in FIG. 3 and hereinafter, this direction is referred to as return direction) which is in the rotational axis direction and in which the first brake pad 65a goes away from the disc rotor 9.

The return spring 74 presses the piston 69 and as a consequence, urges the rotational shaft 612 of the electric motor 61 to rotate reversely in the direction corresponding to the return direction of the piston 69 or the first brake pad 65a (hereinafter referred to as the direction corresponding to the return direction) through a wear compensation mechanism 72, a rotational wedge 71 and a cycloid reduction gear 70, all of which will be referred to later.

Provided in the brake housing 68 to be located between the electric motor 61 and the piston 69 are the aforementioned lock mechanism 63, the cycloid reduction gear 70 for reducing and transmitting the rotation of the electric motor 61, the rotational wedge 71 (corresponding to a movement direction converting mechanism) for converting the rotation by the electric motor 61 into a linear movement to transmit the same to the piston 69, and the wear compensation mechanism 72 which, when wear takes place on the linings 652a, 652b of the brake pads 65a, 65b, protrudes the piston 69 toward the disc rotor 9 by a predetermined amount intermittently in dependence on the wear amount. The cycloid reduction gear 70, the rotational wedge 71 and the wear compensation mechanism 72 will be described later.

A holder 73 arranged in the brake housing 68 is provided to be rotatable relative to the rotational shaft 612 of the electric motor 61 through a radial needle bearing 613. The holder 73 is engaged with the cylinder portion 682 through a key 731 so that it is not rotatable but movable in the rotational axis direction relative to the cylinder portion 682.

The aforementioned load sensors 62 are attached to the rear surface (right side surface in FIG. 3) of the holder 73. The load sensors 62 are three in number and are attached at an equiangular interval on a circle on the holder 73 which takes it center on the axis of the rotational shaft 612 (one only shown in FIG. 3). An end surface of a motor case 616 for the electric motor 61 is able to abut on the surfaces of the respective load sensors 62 opposite to the surfaces at which the respective load sensors 62 are attached to the holder 73.

Thus, the load sensors 62 are configured so that when the brake pads 65a, 65b are being pressed on the disc rotor 9, the load sensors 62 are pressed between the holder 73 receiving a reaction force from the first brake pad 65a and the end surface of the motor case 616 receiving a reaction force from the second brake pad 65b through the brake housing 68 and thus are able to detect a brake force of the brake actuator 6 (which force is being generated on the disc rotor 9) at that time.

The cycloid reduction gear 70 is well known in construction and is provided with an input member 701 and an output member 702. The input member 701 is mounted through a radial needle bearing 614 rotatably relative to an eccentric shaft portion 612a formed on the rotational shaft 612 of the electric motor 61. A protrusion 701a is formed on a rear surface of the input member 701 and is inserted with a play into a concave portion 732 of the holder 73.

The output member 702 taking an annular shape is arranged on the outer peripheral side of the input member 701 and is in mesh with the external surface of the input member 701 at one place in the circumferential direction on the internal surface thereof. The output member 702 is rotatably engaged with the holder 73 through a radial ball bearing 703 and a thrust needle bearing 704.

When the rotational shaft 612 of the electric motor 61 is rotated, the input member 701 is oscillated relative to the output member 72 as it holds the meshing at one place in the circumferential direction, whereby the rotation of the electric motor 61 is reduced and outputted to the output member 702.

The rotational wedge 71 is provided with a rotational member 711, a set of three rolling elements 712, a linear movement member 713 and an annular support plate 714 rotatably supporting the respective rolling elements 712. The rotational member 711 has a sleeve portion 711a that passes through the support plate 714 and the linear movement member 713. The sleeve portion 711a is rotatably mounted on the rotation shaft 612 of the electric motor 61 through a radial needle bearing 615.

Further, the rotational member 711 is formed with a rotational cam (not shown) at a front surface of a portion which is formed to extend radially outside the sleeve portion 711a. Further, the rotational member 711 is connected to the output member 702 of the cycloid reduction gear 70 through a key 711b and is rotatable bodily with the output member 702.

Respective rolling elements 712 are mounted to the support plate 714 on a circle with a center on the axis of the rotation shaft 612 at an equiangular interval. The rolling elements 712 are provided movably together with the support plate 714 in the rotational axis direction relative to the cylinder portion 682.

A rotational cam (not shown) engageable with the rolling elements 712 is formed on a rear end surface of the linear movement member 713. The linear movement member 713 is engaged with the holder 73 through a key 713a not to be rotatable but to be movable in the rotational axis direction relative thereto.

When the rotational member 711 is rotated by the output member 702 of the cycloid reduction gear 70, the rotational movement of the rotational member 711 is converted by the rotational cams provided on the rotational member 711 and the linear movement member 713, into the linear movement in the rotational axis direction of the linear movement member 713.

Since the construction and operation of the rotational wedge 71 is not a main point of the present invention, no further description will be made. Further details of the rotational wedge 71 are described in JP2011-043222 A being a published patent application.

Further, as the movement direction converting mechanism for the brake actuator 6, in place of the rotational wedge 71, there may be useable, for example, a ball ramp mechanism described in JP2003-113877 A or a ball screw described in JP2005-247306 A.

The wear compensation mechanism 72 is arranged between the piston 69 and the rotational wedge 71 and is provided with an input member 721, an output member 722, a lever 723 and a return torsion spring 724. The input member 721 is rotatably provided radially outside the sleeve portion 711a of the rotational member 711. A spherical surface 721a is formed around the inner peripheral portion of the input member 721 and is slidably in contact with a conical surface 713b formed around the inner peripheral portion of the linear movement member 713. With engagement of the spherical surface 721a of the input member 721 and the conical surface 713b of the linear movement member 713, the piston 69 is able to swing relative to the brake housing 68.

The input member 721 is jointed with the sleeve portion 711a of the rotational member 711 through a connection pin 725 and the return torsion spring 724. The input member 721 is connected at its outer peripheral portion to the linear movement member 713 of the rotational wedge 71 through a key 726, and both members are formed to be bodily movable in the rotational axis direction.

The output member 722 is an annular adjusting screw and is formed with ratchet teeth 722a on the whole circumference of the internal surface thereof and a male screw 722b on the external surface portion. Further, a rear surface of the output member 722 is formed to be frictionally engageable with a friction engaging surface 721b provided on a front surface of the input member 721. Respective ratchet teeth 722a are for rotating the output member 722 in one direction by the lever 723, and the lever 723 is formed with a claw (not shown) which is disengageably engaged with the ratchet teeth 722a.

The male screw 722b is engaged with a female screw 692 formed on the internal surface of the piston 69, and by the rotation of the output member 722 in one direction, the piston 69 is able to move toward the disc rotor 9 in the rotational axis direction.

Since the construction and operation of the wear compensation mechanism 72 is not a main point of the present invention, no further description will be made. Further details in construction of the wear compensation mechanism 72 are the same as those described in the aforementioned JP2011-43222 A.

The wear compensation mechanism 72 is not a construction requisite to the electric brake device 1 according to the present invention, and there may be taken a construction that the piston 69 is directly pressed by the linear movement member 713 of the rotational wedge 71.

The lock mechanism 63 is arranged between the electric motor 61 and the cycloid reduction gear 70. As shown in FIG. 3, the lock mechanism 63 is composed of a lock gear 632 which is bodily rotatably secured to the rotational shaft 612 of the electric motor 61, and the aforementioned solenoid actuator 631.

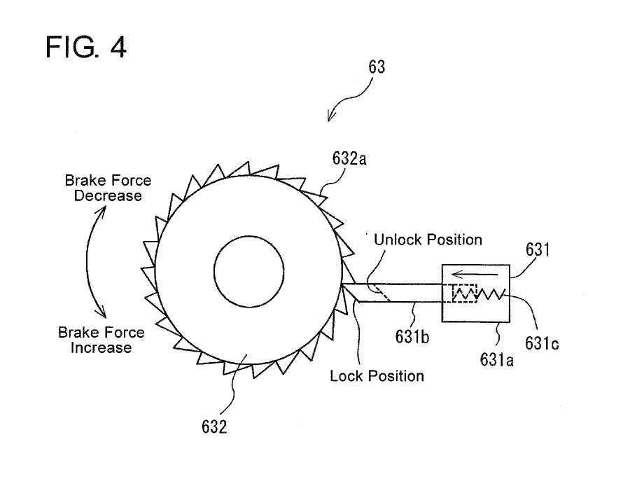

As shown in FIG. 4, a plurality of tooth portions 632a are formed on an external surface of the lock gear 632 over the whole circumference. Each of the tooth portions 632a takes a nearly triangle shape in section which is formed by a pair of slant surfaces. In each tooth portion 632a, the inclination of one slant surface is formed to be larger than that of the other slant surface so that when each tooth portion 632a is engaged with a plunger member 631b of the solenoid actuator 631, the electric motor 61 is allowed to rotate in a direction corresponding to the direction (hereinafter referred to as forward direction) in which the piston 69 is moved to come close to the disc rotor 9, but is restrained from rotating in a direction corresponding to the return direction.

The solenoid actuator 631 is attached to the brake housing 68 and, as shown in FIG. 4, is composed of an actuator main body 631a, a plunger member 631b movably connected to the actuator main body 631a, and a lock spring 631c urging the plunger member 631b in the direction to engage with the lock gear 632.

The actuator main body 631a includes a solenoid (not shown), and, when electrified, the solenoid urges the plunger member 631b in the direction to be released from engagement with the lock gear 632 against the urging force of the lock spring 631c. Thus, when the solenoid is not electrified, the lock mechanism 63 is able to hold the electric motor 61 in the state that the electric motor 61 is restrained from rotating in the direction corresponding to the return direction.

An electric parking brake device PD is constructed by the brake actuator 6, the EPB operation member 3, the EPB control section 21, the feedback control section 24, the motor driver 25 and the solenoid driver 23 all aforementioned.

Hereinafter, prior to the description of a gap adjusting control being the subject of the present invention, description will be made regarding a foot brake control and an EPB operating control.

<Foot Brake Control>

When the brake pedal BP of the vehicle V is operated, the EPB control section 21 that receives a brake operating signal from the feedback control section 24 operates the solenoid actuator 631 to release the holding by the lock mechanism 63 of the electric motor 61 (unlock position).

Thereafter, the feedback control section 24 performs a feedback control based on a required brake force which is calculated by the required brake force calculating section 22 in dependence on a braking operation amount, and a brake force which is being generated by the brake actuator 6 and which is detected by the load sensors 62, and supplies the electric motor 61 with an appropriate electric current meeting the required brake force.

When by being supplied with the electric current, the electric motor 61 is rotated in the direction corresponding to the forward direction, the rotation of the electric motor 61 is reduced by the cycloid reduction gear 70 and is transmitted to the rotational member 711 of the rotational wedge 71. The rotational movement of the rotational member 711 is converted by the rotational wedge 71 into the linear movement in the rotational axis direction of the linear movement member 713 and is transmitted to the wear compensation mechanism 72. The input member 721 of the wear compensation mechanism 72 urged by the linear movement member 713 urges, together with the output member 722, the piston 69 in the forward direction (leftward in FIG. 3) toward the disc rotor 9 against the urging force of the return spring 74.

Thus, the piston 69 presses the first brake pad 65a on the disc rotor 9. At this time, the input member 721 and the output member 722 of the wear compensation mechanism 72 are moved bodily due to the friction engaging force between the both members, so that the rotation of the output member 722 does not take place.

On the other hand, a reaction force generated in the return direction (rightward in FIG. 3) as a result that the first brake pad 65a presses the disc rotor 9 is transmitted to the brake housing 68 through the first brake pad 65a, the piston 69, the output member 722, the input member 721, the linear movement member 713, the rolling elements 712, the rotational member 711, the output member 702, the thrust needle bearing 704, the holder 73, the load sensors 62 and the electric motor 61 and urges the brake housing 68 in the opposite direction to the piston 69 (rightward in FIG. 3).

Thus, the brake housing 68 is moved in the return direction, and this causes the claw portions 681 urge the second brake pad 65b toward the disc rotor 9. Accordingly, the disc rotor 9 is pressed by the first brake pad 65a and the second brake pad 65b to apply a brake force to the wheel W.

Further, when in releasing the brake force from the disc rotor 9, the electric motor 61 is rotated reversely in the direction corresponding to the return direction, the piston 69 is moved by the urging force of the return spring 74 in the return direction to stop the pressing on the first brake pad 65a. As a result, since the reaction force generated on the first brake pad 65a is removed, the pressing by the claw portions 681 of the brake housing 68 on the second brake pad 65b is also removed to release the brake force from the wheel W.

During the foot brake control, the solenoid actuator 631 remains in operation, so that the lock mechanism 63 is held in the unlock position.

<EPB Operating Control>

When detecting that the EPB operating member 3 is brought into operation at the time of parking the vehicle V, the EPB control section 21 operates the solenoid actuator 631 to release the holding by the lock mechanism 63 of the electric motor 61 (unlock position). Thereafter, the feedback control section 24 drives the electric motor 61 upon receiving the EPB operating signal from the EPB control section 21 and causes the brake actuator 6 to generate a predetermined brake force.

When the load sensors 62 detect that the predetermined brake force is generated by the brake actuator 6, the feed back control section 24 transmits a pressuring completion signal to the EPB control section 21. Upon receiving the pressuring completion signal, the EPB control section 21 discontinues the operation of the solenoid actuator 631 to restrict the rotation of the electric motor 61 by the lock mechanism 63 (lock position). Thereafter, upon receiving a lock completion signal from the EPB control section 21, the feedback control section 24 discontinues the supplying of electric current to the electric motor 61.

When the EPB operation control is released, the EPB control section 21 operates the solenoid actuator 631 to release the holding by the lock mechanism 63 of the electric motor 61, and the feedback control section 24 rotates the electric motor 61 reversely in the direction corresponding to the return direction (step S601 referred to later).

<Gap Amount Adjusting Control>

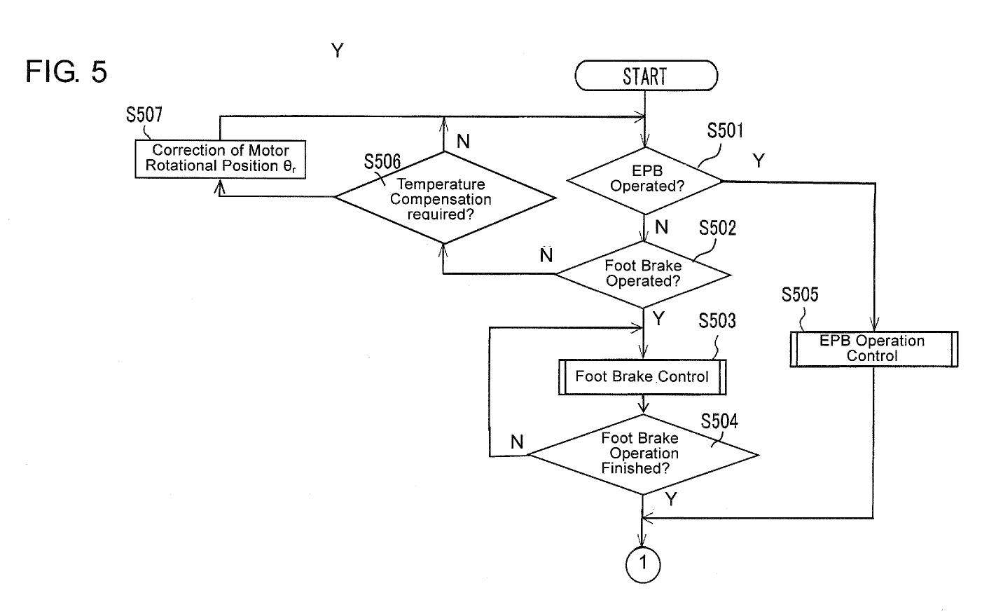

Next, a gap amount adjusting control in the electric brake device 1 being the subject of the present invention will be described with reference to FIGS. 5 through 7.

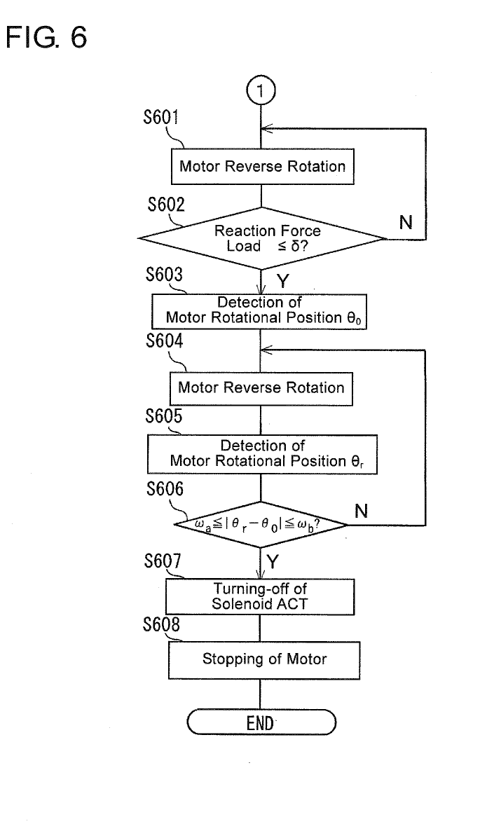

When the EPB operating member 3 is judged by the EPB control section 21 to have been operated (step S501 in FIG. 5), the aforementioned EPB operation control is executed (step S505). Upon termination of the EPB operation control, step S601 (in FIG. 6) is reached.

When the EPB operating member 3 is not operated, it is judged through the pedal stroke sensor 4 or the pedal stepping force sensor 5 whether or not the brake pedal BP of the vehicle V has been operated (step S502). If the brake pedal BP is judged to have been operated, the aforementioned foot brake control is executed (step S503). The foot brake control is continued until the operation of the brake pedal BP is finished (step S504).

If at step S502, the brake pedal BP is judged not to have been operated, it is judged whether or not a temperature compensation is to be made with respect to the gap amount between the brake pads 65a, 65b and the disc rotor 9 (step S506). Steps S506 and S507 will be described later.

When the operation of the brake pedal BP is judged at step S504 to have been finished or when the EPB operation control indicated at step S505 is judged to have been released, the feed back control section 24 makes the electric motor 61 rotate in the direction corresponding to the return direction to release the pressing by the piston 69 against the first brake pad 65a (step S601).

With the movement of the piston 69 in the return direction, the detection load (f) of the load sensors 62 drops gradually, and judgment is made of whether or not the detection load (f) of the load sensors 62 has become equal to or less than δ (step S602). The value δ is set to a value being very close to zero. The electric motor 61 is driven in the direction corresponding to the return direction until the detection load (f) becomes equal to or less than δ.

When the detection load (f) of the load sensors 62 becomes equal to or less than δ, the rotational position θ₀ (origin position) of the electric motor 61 at that time is detected by the resolver 611 (step S603). Usually, the position of the brake housing 68 is determined so that the reaction force received by the first brake pad 65a from the disc rotor 9 balances with the reaction force received by the second brake pad 65b from the disc rotor 9. Thus, at the time when the rotational position of the electric motor 61 is at the origin position θ₀, the disc rotor 9 does not receive any pressing force from both of the first brake pad 65a and the second brake pad 65b, so that the brake force by the brake actuator 6 has been removed.

Thereafter, as the electric motor 61 is further driven in the direction corresponding to the return direction (step S604: corresponding to a gap adjusting step), the rotational position θᵣ of the electric motor 61 is detected by the resolver 611 (step S605: corresponding to the gap adjusting step). Based on the detected rotational position θᵣ of the electric motor 61, judgment is made of whether or not the difference |θᵣ-θ₀| between the present rotational position θᵣ and the origin position θ₀ of the electric motor 61 is within a range of ωₐ or larger to ω_{b} or less (step S606: corresponding to a gap judging step).

In the brake control device 2, a reference range has been set in advance for the gap amounts between the brake pads 65a, 65b and the disc rotor 9. The reference range for the gap amounts means the range for the respective gap amounts between both of the brake pads 65a, 65b and the disc rotor 9 which range prevents the dragging or locking while the braking is not being performed and which range makes it possible to maintain the responsiveness in operation when the next braking operation is performed.

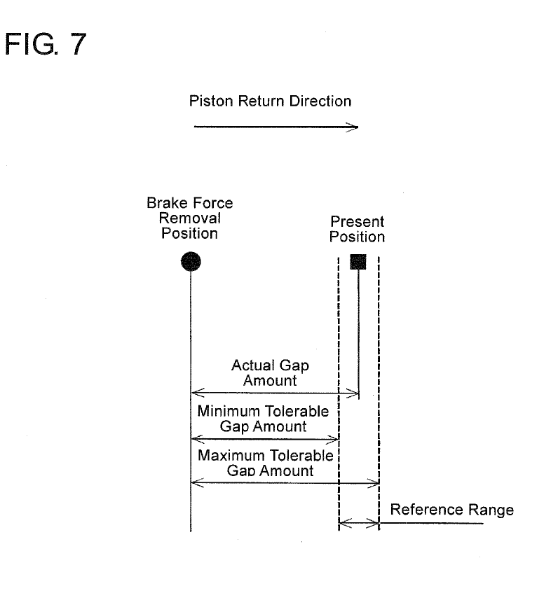

At step S604 through step S606, when the electric motor 61 is rotated in the direction corresponding to the return direction, the rotational position of the electric motor 61 is controlled in such a way that, assuming an actual gap amount as the amount for the piston 69 to be displaced from the position where the brake force is removed, as shown in FIG. 7, the actual gap amount exists within the aforementioned reference range between a minimum tolerable gap amount and a maximum tolerable gap amount.

Here, the aforementioned range of ωₐ or larger to ω_{b} or less for the rotational position of the electric motor 61 corresponds to the values (reference rotational range) which are obtained by converting the aforementioned reference range for the gap amounts between the brake pads 65a, 65b and the disc rotor 9 into the rotational amount of the electric motor 61. That is, the reference rotational range corresponds to the range for such a value that, when the electric motor 61 is rotated in the direction corresponding to the return direction, the amount by which the electric motor 61 is rotationally displaced from the rotational position θ₀ (origin position) where the brake force is removed is able to prevent the dragging or locking while the brake is not being operated, and to maintain the responsiveness in operation when the next braking operation is performed.

Here, usually, thanks to the axial runout or the like of the disc rotor 9, the gap amounts between the brake pads 65a, 65b and the disc rotor 9 are equally formed at respective spaces between the disc rotor 9 and both of the brake pads 65a, 65b. Thus, the reference rotational range (ωₐ or larger to ω_{b} or less) indicated at step S606 becomes the values that are obtained by converting the sum of the gap amounts to be formed between the disc rotor 9 and both of the brake pads 65a, 65b into the rotational displacement amount of the electric motor 61.

Referring back to FIG. 6, at step S604, the electric motor 61 is driven in the return direction until the difference |θᵣ-θ₀| between the present rotational position θᵣ and the origin position θ₀ of the electric motor 61 comes into the aforementioned reference rotational range.

When the difference between the rotational position θᵣ and the origin position θ₀ of the electric motor 61 comes into the reference rotational range, the feedback control section 24 transmits an adjusting completion signal to the EPB control section 21. The EPB control section 21 upon receiving the adjusting completion signal stops the operation of the solenoid actuator 631 and restricts the rotation of the electric motor 61 by the lock mechanism 63 with the gap amounts adjusted between the disc rotor 9 and the brake pads 65a, 65b (step S607). Thereafter, the feedback control section 24 upon receiving the lock completion signal from the EPB control section 21 stops the supplying of electric current to the electric motor 61 (step S608).

When the vehicle V is traveling with the gap amounts adjusted between the disc rotor 9 and the brake pads 65a, 65b, the temperature sensors 64 may detect a change in temperature of the disc rotor 9 or the brake pads 65a, 65b (step 506 in FIG. 5). In this case, the motor position correcting section 26 transmits a lock release signal to the EPB control section 21 to operate the lock mechanism 63 to the unlock position. With this, the motor position correcting section 26 transmits a temperature compensation signal to the feedback control section 24 to change the rotational position θᵣ of the electric motor 61. Thus, the gap amounts between the disc rotor 9 and the brake pads 65a, 65b are corrected based on a map or the like specifying the relation between temperature change amounts of the disc rotor 9 or the brake pads 65a, 65b and correction amounts (step S507).

After the correction of the gap amounts, the EPB control section 21 brings the solenoid actuator 631 into the out-of-operation to return the lock mechanism 63 to the lock position.

When the disc rotor 9 and the brake pads 65a, 65b do not change in temperature, the adjusted gap amounts are maintained.

According to the present embodiment, when the brake pads 65a, 65b are not in the pressing state, the electric motor 61 is driven to adjust the gap amounts between the brake pads 65a, 65b and the disc rotor 9 so that the gap amount comes into the reference range, and the rotation of the electric motor 61 is restricted by the lock mechanism 63 with the gap amounts having been adjusted. Therefore, it is possible to hold the rotational position of the electric motor 61 with the gap amounts existing within the reference range when the brake is out of operation. In spite of the wear on the brake pads 65a, 65b or the deterioration of the return spring 74, it is also possible to prevent the dragging or locking while the brake is not being operated, and to improve the responsiveness in operation when the next braking operation is performed.

Further, the rotation of the electric motor 61 is restricted by the lock mechanism 63 with the gap amounts between the brake pads 65a, 65b and the disc rotor 9 existing within the reference range. Therefore, when the brake is not being operated, it is possible to hold the positions of the brake pads 65a, 65b without operating the electric motor 61 and hence, to realize a decrease in electric power consumption, the prevention of the electric motor 61 from deterioration and heating, and a long service life.

Further, since the position of the piston 69 is not required to be kept by the electric motor 61 for a long period of time, it becomes possible to downsize the electric motor 61 and to realize a reduction in cost of the electric brake device 1.

Further, since the lock mechanism 63 is included in the electric parking brake device PD that restricts the rotation of the electric motor 61 at the time of parking the vehicle V, it is not necessary to provide a lock mechanism 63 additionally. As a result, the electric brake device 1 can be made to be easy in manufacturing and low in cost.

Further, the reference rotational range is taken as the values which are obtained by converting the reference range into the rotational positions of the electric motor 61. In adjusting the gap amounts, the origin position θ₀ is set as the rotational position of the electric motor 61 where the brake force generated on the disc rotor 9 is removed as the piston 69 is moved in the return direction after releasing the pressings by the brake pads 65a, 65b, and the rotational position θᵣ is adjusted so that the difference between the rotational position θᵣ and the origin position θ₀ of the electric motor 61 in the further movement of the piston 69 in the return direction comes into the reference rotational range. Therefore, it is possible to easily adjust the gap amounts between the brake pads 65a, 65b and the disc rotor 9 when the braking operation is released.

Further, when the brake pads 65a, 65b are not in the pressing state, the gap amounts are corrected based on a change in temperature of the brake pads 65a, 65b or the disc rotor 9. Therefore, even if a change in shape occurs on the brake pads 65a, 65b or disc rotor 9 due to a change in temperature to vary the gap amounts therebetween when the rotation of the electric motor 61 is restricted with the gap amounts having been adjusted, it is possible to correct the gap amounts again to appropriate amounts.

### Other Embodiments

The present invention is not limited to the aforementioned embodiment and may be modified or extended as follows.

As brake force detecting means, instead of the load sensors 62, there may be used a pressure sensor, a torque sensor for detecting the brake torque of the disc rotor 9, or the like.

Further, as urging means, instead of the return spring 74 engaged with the piston 69, there may be used an urging member that is engaged with the electric motor 61, the cycloid reduction gear 70 or the rotational wedge 71 to urge one so engaged in the return direction. Further, for the urging means, besides the compression spring, there may be used a spring member of any kinds such as conical spring, leaf spring and the like or a member of any kinds such as elastic rubber or the like for urging the piston 69 in the return direction.

Further, in order to detect the rotational position of the electric motor 61, it is possible to use, instead of the resolver 611, an encoder or any other motor position detecting sensor.

Further, instead of taking the construction that turns to the unlock position by electrifying the solenoid, the lock mechanism 63 may take a construction that turns to the lock position by electrifying the solenoid. In this case, where there is taken a construction that the engagement between the plunger member 631b of the solenoid actuator 631 and a tooth portion 632a of the lock gear 632 is mechanically held even if the electric current to the solenoid is discontinued, it is possible to discontinue the supplying of electric current to the solenoid after the lock mechanism 63 is turned to the lock position by electrifying the solenoid.

Further, the lock mechanism 63 may take a construction that holds the rotational position of the electric motor 61 through engagement with the cycloid reduction gear 70 or the rotational wedge 71.

Further, the correction of the gap amounts on the basis of a change in temperature of the disc rotor 9 or the brake pads 65a, 65b may be made based on the elapsed time after the adjustment of the gap amounts, instead of the detected temperature by the temperature sensors 64. Alternatively, the correction may be made based on both of the detected temperature by the temperature sensors 64 and the elapsed time after the adjustment of the gap amounts.

In adjusting the gap amounts, it may be done to adjust the gap amounts into the reference range by driving, after detecting the origin position θ₀ of the electric motor 61, the electric motor 61 in the direction corresponding to the return direction to move the first brake pad 65a to the most separated position from the disc rotor 9, by stopping the operation of the solenoid actuator 631 at that time, and by moving the first brake pad 65a in the direction to come close to the disc rotor 9 by the electric motor 61 with the lock mechanism restraining the rotation of the electric motor 61 in the return direction.

Further, in detecting the gap amounts between the disc rotor 9 and the brake pads 65a, 65b, a distance sensor of a laser or ultrasonic type or the like may be used in place of converting the gap amounts into the rotational amount of the electric motor 61.

Further, the present invention is applicable not only to a floating-type disc brake that puts and presses the disc rotor 9 between and by the claw portions 681 of the brake housing 68 and the piston 69a, but also to a facing-type disc brake that presses both side surfaces of the disc rotor 9 by pistons.

Further, as the electric motor 3, there is usable a motor of any kinds including a synchronous motor, an induction motor, a DC motor and the like.

### INDUSTRIAL APPLICABILITY

The electric brake device and the control method for the electric brake device according to the present invention can be utilized for four-wheel vehicles, two-wheel vehicles and other vehicles.

### DESCRIPTION OF SYMBOLS

In the drawings, 1 designates electric brake device, 2 brake control device (control means), 9 disc rotor (braked member), 61 electric motor, 62 load sensors (brake force detecting means), 63 lock mechanism, 65a first brake pad (braking member), 65b second brake pad (braking member), 69 piston, 71 rotational wedge (movement direction converting mechanism), 74 return spring (urging means), 243 gap judging section (gap judging means), 244 gap adjusting section (gap adjusting means), 611 resolver (motor position detecting means), PD electric parking brake device, V vehicle, and W designates wheel.

1-5. (canceled)

6. An electric brake device comprising:
a piston that presses a braking member on a braked member rotating bodily with a wheel;
a brake force detecting sensor that detects a brake force generated on the braked member;
an electric motor that rotates by being supplied with electric current based on a braking operation amount and a brake force detected by the brake force detection sensor;
a movement direction converting mechanism that converts the rotation of the electric motor into a linear movement to transmit the linear movement to the piston;
an urging member that urges the electric motor to rotate in a return direction being the direction in which the braking member goes away from the braked member;
a lock mechanism that is able to hold the electric motor with the rotation restricted in at least the return direction; and
a control device that controls the operations of the electric motor and the lock mechanism;
wherein the control device includes:
a gap judging section that judges whether or not the gap amount between the braking member and the braked member exists within a reference range, when the braking member is not in a pressing state; and
a gap adjusting section that drives the electric motor to adjust the gap amount when the gap amount is judged by the gap judging section not to exist within the reference range; and
wherein the control device is configured to drive the electric motor to adjust the gap amount so that the gap amount comes into the reference range, when the braking member is not in the pressing state, and is configured to restrict the rotation of the electric motor by the lock mechanism with the gap amount adjusted.

7. The electric brake device as set forth in claim 6, wherein the lock mechanism is included in an electric parking brake device that, at the time of parking the vehicle, restricts the rotation of the electric motor with a brake force generated on the braked member.

8. The electric brake device as set forth in claim 6, further comprising:
a motor position detecting device that detects the rotational position of the electric motor;
wherein the control device has a reference rotational range set as values which are obtained by converting the reference range into the rotational positions of the electric motor; and
wherein the control device is configured to take, in adjusting the gap amount, as an origin position a rotational position of the electric motor when a brake force generated on the braked member and detected by the brake force detecting means is removed as the piston is moved in the return direction after releasing the pressing of the braking member, and to adjust the rotational position of the electric motor so that the difference between the rotational position of the electric motor and the origin position in a further movement of the piston in the return direction comes into the reference rotational range.

9. The electric brake device as set forth in claim 6, wherein the control device is configured to correct the gap amount based on a change in temperature of the braking member or the braked member, when the braking member is not in the pressing state.

10. A method for controlling an electric brake device comprising;
a piston that presses a braking member on a braked member rotating bodily with a wheel;
a brake force detecting sensor that detects a brake force generated on the braked member;
an electric motor that rotates by being supplied with electric current based on a braking operation amount and a brake force detected by the brake force detecting sensor;
a movement direction converting mechanism that converts the rotation of the electric motor into a linear movement to transmit the linear movement to the piston;
an urging member that urges the electric motor in a return direction being a direction in which the braking member goes away from the braked member; and
a lock mechanism that is able to hold the electric motor with the rotation restricted in at least the return direction;
the method comprising:
a gap judging step of judging whether or not the gap amount between the braking member and the braked member exists within a reference range, when the braking member is not in a pressing state;
a gap adjusting step of adjusting the gap amount by driving the electric motor when the gap amount is judged at the gap judging step not to exist within the reference range, whereby the gap amount is adjusted to come into the reference range; and
a rotation restricting step of restricting the rotation of the electric motor by the lock mechanism, with the gap amount having been adjusted.
